(19) United States
(12) Patent Application Publication
(10) Pub. No.: US 2011/0006958 A1
(43) Pub. Date: Jan. 13, 2011

(54) System And Method For Reducing The Sway Of A Vehicle Antenna

(76) Inventor: Alan G. Frederick, Southbury, CT (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/499,252

(22) Filed: Jul. 8, 2009

(51) Int. Cl. H01Q 1/32

(52) U.S. Cl. 343/715

(57) ABSTRACT

A system is provided for reducing the sway of a vertically-oriented antenna of a vehicle. The system includes a one-piece mount secured to a fixed location on an exterior surface of the vehicle. The fixed location is selected such that upon securing the one-piece mount to the fixed location, a top end of the vertically-oriented antenna passes through an opening in the one-piece mount, and the top end of the vertically-oriented antenna is positioned adjacent to the opening. Additionally, a method is provided for reducing the sway of an antenna of a vehicle.

### FIELD OF THE INVENTION

The system relates generally to vehicle antennas, and more specifically, to a stationary mount configured to reduce the sway of a vehicle antenna.

### BACKGROUND OF THE INVENTION

Vehicle antennas, particularly vehicle antennas having a vertical orientation, are prone to sway back and forth while the vehicle travels along a road or highway. The degree of this sway varies, depending on the type of vehicle, the size of the antenna, and the speed at which the vehicle travels, among other factors. For example, CB (Citizens' Band) Antennas positioned on a motor home or RV (recreational vehicle), are prone to a high degree of sway, and may cause a loud “whipping” sound, as the vehicle approaches highway speeds. For a vertically-oriented antenna, the tip of the antenna tends to sway to a greater extent than the base, and thus significantly contributes to the “whipping” sound. Such “whipping” sounds may be heard by the drivers and passengers, and may be distracting.

Several conventional systems have been designed, to mount an antenna to a vehicle. For example, U.S. Pat. No. 2,203,945 to Roo et al. discloses an antenna mount designed to secure the antenna across the roof of a vehicle. However, this system would degrade the signal of vertically-oriented antennas, as the antenna would be horizontally extended over the roof of the vehicle, instead of being permitted to retain its intended vertical orientation.

Additionally, U.S. Pat. No. 2,146,654 to Shea et al. and U.S. Pat. No. 3,134,978 to Arvay Jr disclose an antenna mount secured to the side of a vehicle. However, since the mounts in both Shea et al. and Arvay Jr. are positioned adjacent to a base of the antenna, these mounts would have a negligible effect on the sway of the antenna top end or tip, and thus have a negligible effect on the “whipping” sound produced by the antenna sway.

Accordingly, there is a need for an antenna mount for a vehicle which is properly positioned relative to the antenna and adequately structured, to minimize the sway of the antenna, to thereby minimize the “whipping” sound produced by such antenna sway.

### BRIEF DESCRIPTION OF THE INVENTION

In one embodiment of the present invention, a system is provided for reducing the sway of a vertically-oriented antenna of a vehicle. The system includes a one-piece mount secured to a fixed location on an exterior surface of the vehicle. The fixed location is selected such that upon securing the one-piece mount to the fixed location, a top end of the vertically-oriented antenna passes through an opening in the one-piece mount, and the top end of the vertically-oriented antenna is positioned adjacent to the opening.

In another embodiment of the present invention, a system is provided for reducing the sway of a vertically-oriented antenna of a vehicle. The system includes a mount secured to a fixed location on an exterior surface of the vehicle. The fixed location is selectively determined so that upon passing a top end of the vertically-oriented antenna through an opening in the mount, the top end is adjacent to the opening and a sway of the top end during an operation of the vehicle is reduced.

In another embodiment of the present invention, a method is provided for reducing the sway of a vertically-oriented antenna of a vehicle. The method includes selecting a fixed location on an exterior surface of the vehicle. Additionally, the method includes securing a one-piece mount to the fixed location, and passing a top end of the vertically-oriented antenna through an opening in the one-piece mount, such that the top end is positioned adjacent to the opening.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side view of an exemplary embodiment of a system for reducing the sway of an antenna of a vehicle in accordance with the present invention;

FIG. 2 is a cross-sectional view of a one-piece mount secured to the vehicle in FIG. 1 taken along the line II-II;

FIG. 3 is a top perspective view of the one-piece mount illustrated in FIG. 2, with the antenna removed from the one-piece mount;

FIG. 4 is a side perspective view of the one-piece mount illustrated in FIG. 2;

FIG. 5 is a side perspective view of a material including a first and second member from which the one-piece mount illustrated in FIG. 3 is formed; and

FIG. 6 is a flowchart depicting an exemplary embodiment of a method for reducing the sway of an antenna of a vehicle in accordance with the present invention.

### DETAILED DESCRIPTION OF THE INVENTION

Though exemplary embodiments of the present invention are described with respect to antennas used with vehicles, specifically vertically-oriented CB antennas, VHF antennas, and AM/FM stereo antennas used with such vehicles as RV's (recreational vehicles), campers, trailers and pick-up trucks, for example, embodiments of the invention are also applicable for use with other types of antennas used with other types of vehicles, such as a standard radio antenna (regardless of the orientation) used in a standard automobile, and CB antennas, VHF antennas and AM/FM stereo antennas used with any vehicle, regardless of the orientation.

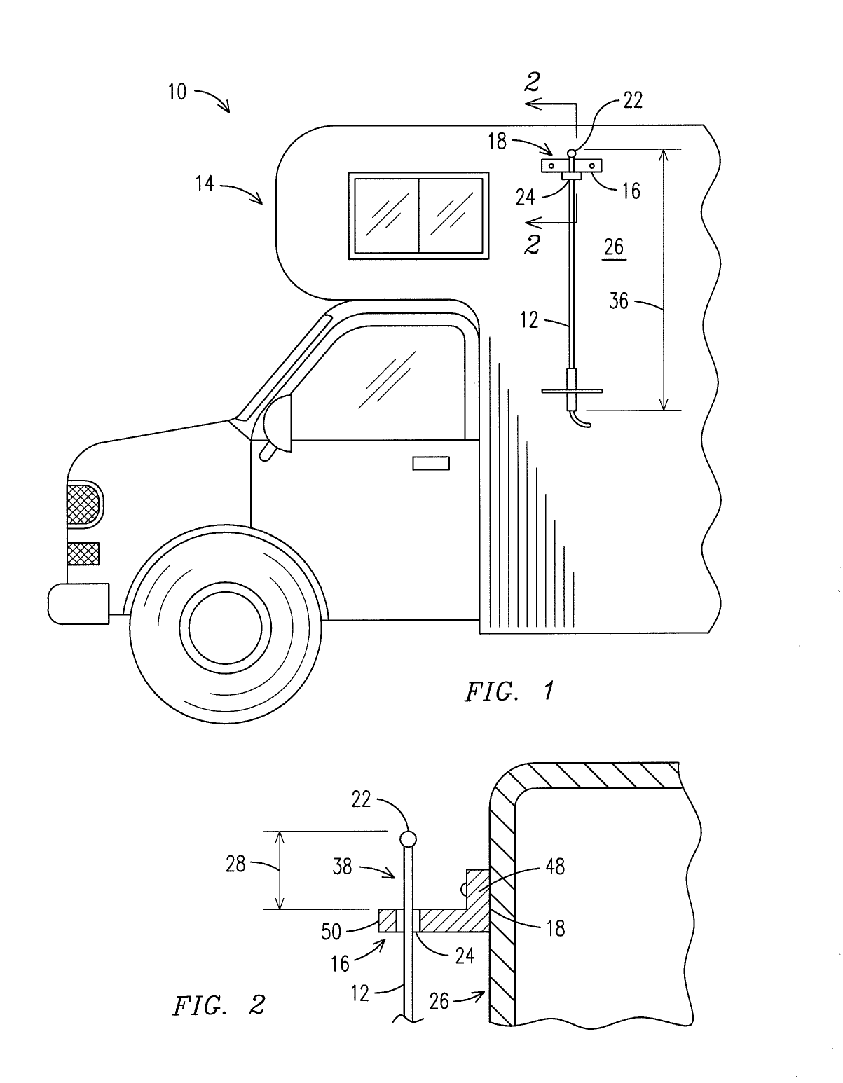

FIG. 1 illustrates an exemplary embodiment of a system 10 for reducing the sway of an antenna 12 of a vehicle 14. As discussed above, the vehicle 14 may be an RV, a camper, a trailer, a pick-up truck, or a regular automobile. However, the present invention is not limited to any particular type of vehicle. Additionally, as discussed above, the antenna may be a CB antenna, a VHF antenna, an AM/FM antenna, or any antenna used with a vehicle. Although the antenna 12 illustrated in FIG. 1 has a vertical orientation, the antenna utilized in the system 10 need not have a vertical orientation.

A one-piece mount 16 is secured to a fixed location 18 on an exterior surface, such as a side 26 (FIG. 2) of the vehicle 14. For example, if the antenna 12 is aligned along the side 26 of the vehicle 14, the one-piece mount 16 is secured to the fixed location 18 on the side 26 of the vehicle 14. As discussed in further detail below, the fixed location 18 is selected such that upon securing the one-piece mount 16 to the fixed location 18, a top end (or tip) 22 of the antenna 12 passes through an opening 24 in the one-piece mount 16. A dimension of the opening 24, such as an inner diameter, for example, may be sized to accommodate a dimension of the antenna 12, such as a diameter. For example, in an exemplary embodiment, an inner diameter of the opening 24 may be ⅜″ to accommodate the antenna 12 having a diameter less than ⅜″.

As illustrated in FIGS. 1-2, the antenna 12 is a vertically-oriented antenna, and the one-piece mount 16 is secured to the fixed location 18 on the side 26 of the vehicle 14 such that the opening 24 is vertically oriented to receive the antenna 12. However, as previously discussed, the antenna need not be a vertically-oriented antenna, and thus the one-piece mount may be secured to the fixed location at a fixed location at any exterior surface of the vehicle, such that the opening is oriented to receive the antenna (depending on the orientation of the antenna).

The fixed location 18 is selected such that, upon securing the one-piece mount 16 to the fixed location 18, the opening 24 is positioned at a maximum threshold distance 28 (see FIGS. 2, 4) below the top end 22 of the antenna 12. The maximum threshold distance 28 is based on a vertical height range 30 (FIG. 4) over which the height of the top end 22 of the antenna 12 varies as the antenna 12 sways within the opening 24, for a range of vehicle 14 operating speed. Thus, for a range of vehicle 14 operating speed, the antenna 12 will tend to sway (to a negligible degree) within the opening 24, and thus cause the height of the top end 22 of the antenna 12 to vary across the vertical height range 30.

In an exemplary embodiment, the maximum threshold distance 28 is adjusted to be greater than the vertical height range 30. By selecting a fixed location 18 such that the maximum threshold distance 28 is greater than the vertical height range 30, the antenna 12 will remain within the opening 24 throughout the range of vehicle 14 operating speed, and sway to a negligible degree. Once the maximum threshold distance 28 is greater than the vertical height range 30, increasing the maximum threshold distance 28 even more results in a more stable positioning of the antenna 12 within the opening 24, yet may cause the antenna 12 and the top end 22 to sway to a greater extent within the opening 24.

However, the fixed location 18 may be selected without regard to the vertical height range 30. In an exemplary embodiment, the maximum threshold distance 28 is adjusted to a within a distance range, which achieves a secure positioning of the antenna 12 within the opening 24, while also minimizing the extent of sway of the antenna 12 and top end 22 within the opening 24. For example, the maximum threshold distance 28 may be adjusted such that the ratio of the length of the antenna 12 which extends through the opening 24 (a top portion 38, as described below) may be 5-10% of the length 36 of the antenna 12, for example. The maximum threshold distance 28 may be based on any predetermined ratio range of the top portion 38 to the length 36 of the antenna 12.

As further illustrated in FIGS. 1, 2 and 4, upon securing the one-piece mount 16 to the fixed location 18, the top end 22 of the antenna 12 is positioned adjacent to the opening 24, and a top portion 38 of the antenna 12 which is adjacent to the top end 22, and positioned between the top end 22 and the opening 24, is also positioned adjacent to the opening 24. As discussed above, the top portion 38 represents a ratio of the length 36 of the antenna 12 which extends through the opening 24. In an exemplary embodiment, the top portion 38 may be in a range of 5-10% of the length 36 of the antenna 12, or may be within any predetermined ratio range of the length 36 of the antenna 12, provided that the sway and/or a “whipping” sound produced by the antenna 12 are minimized. The opening 24 reduces the “whipping” sound produced by the top end 22 and the top portion 38 of the antenna 12 when the vehicle 14 reaches a threshold speed, such as a highway speed, for example. As discussed above, the embodiments of the present invention are not limited to any particular antenna and particular vehicle, and any particular antenna and particular vehicle involve a respective threshold speed at which the “whipping” sound is produced by the top end and the top portion of the antenna, based on the configuration, dimensions, etc. of the antenna/vehicle combination.

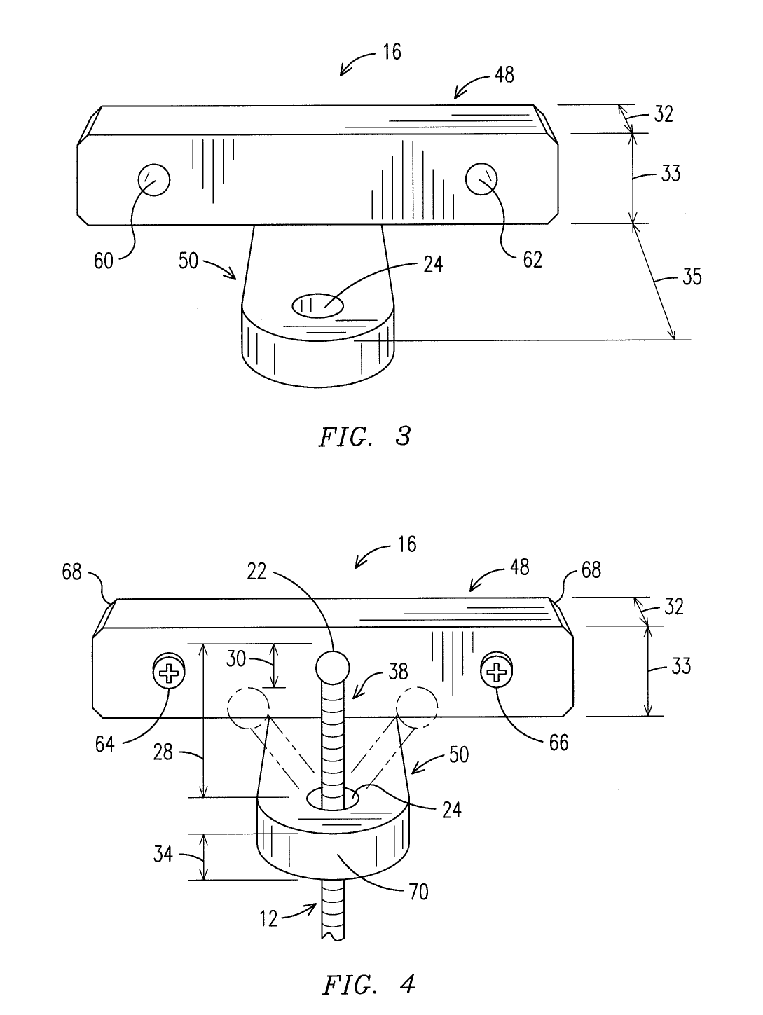

In the design phase of the one-piece mount 16, a dimension 32,33,34,35 (see FIGS. 3-4) of the one-piece mount 16 is selectively determined, based on a length 36 of the antenna and/or a type of the vehicle 14, among other factors, such as the type of the antenna, and the diameter of the antenna 12. The one-piece mount 16 is made from a material 40 (FIG. 5) having a first member 42 and a second member 44 integrated over a substantial orthogonal joint 46. However, the one-piece joint need not be made from the material illustrated in FIG. 5, and may be made from material having integrated members joined over a non-orthogonal joint. In an exemplary embodiment, the material 40 may be a polyethylene angle stock made from polyethylene which is not prone to corrode or rust in various weather extremities, and is a relatively strong, light-weight material which provides greater internal strength than two individual pieces of the same material, for example. However, the material used to form the joint need not be a one-piece, integrated material, provided that once the joint is secured to the exterior surface of the vehicle, the joint opening receives the top end of the antenna in the manner described above, in order to reduce the “whipping” sound produced by the antenna.

As illustrated in FIGS. 2-4, a first portion 48 of the one-piece mount 16 is secured to the fixed location 18, while a second portion 50 of the one-piece mount 16 is integral with the first portion 48, includes the opening 24 and extends away from the fixed location 18. As illustrated in FIG. 5, the first portion 48 of the one-piece mount 16 is cut out from the first member 42 of the material 40 and the second portion 50 of the one-piece mount 16 is cut out from the second member 44 of the material 40, while the joint 46 remains intact. The material 40 is selected such that a thickness 52,53,54,55 (see FIG. 5) of the first and second members 42,44 is based on a respective dimension 32,33,34,35 (see FIGS. 3-4) of the first and second portion 48,50. In an exemplary embodiment, the material 40 (and thus the one-piece mount 16) is made from a non-conductive material, to eliminate any signal interference based on contact with the antenna 12 in the opening 24.

As further illustrated in FIG. 4, upon cutting the first and second portions 48,50 from the first and second members 42,44, the corners 68 of the first portion 48 are beveled, and an edge 70 of the second portion 50 is rounded, to enhance the design, and reduce the likelihood that a sharp edge of the one-piece mount 16 could accidentally make contact with an individual. Additionally, a pair of holes 60,62 (FIG. 3) are formed in the first portion 48, while a corresponding pair of holes (not shown) are formed in the fixed location 18, which align with the respective holes 60,62. A pair of screws 64,66 (FIG. 4) may then be passed through the holes 60,62 of the first portion 48 and into the holes (not shown) of the fixed location, to secure the one-piece mount 16 to the fixed location 18. However, any means of securing the one-piece mount 16 to the fixed location 18 may be employed.

As illustrated in FIG. 4, once the first and second portions 48,50 have been cut from the respective first and second members 42,44 of the material 40, the first and second portions 48,50 are respectively aligned in a substantially orthogonal alignment. However, the orthogonal alignment of the first and second portions 48,50 illustrated in FIG. 4 is not necessary, and the first and second portions may be configured to have any mutual alignment, provided that the first portion is secured to the fixed location, and the second portion receives the top end of the antenna through the opening.

As discussed above, in an exemplary embodiment, the opening 24 may be ⅜″ in diameter, to receive the antenna 12. Additionally, in this same exemplary embodiment, the holes 60,62 may be 9/64″ in diameter, to receive two #10×1″ Phillips screws, for example. Additionally, in this exemplary embodiment, the one-piece mount 16 dimensions 32,33,34,35 may be ½″, 1½″, ½″, and 3″, for example.

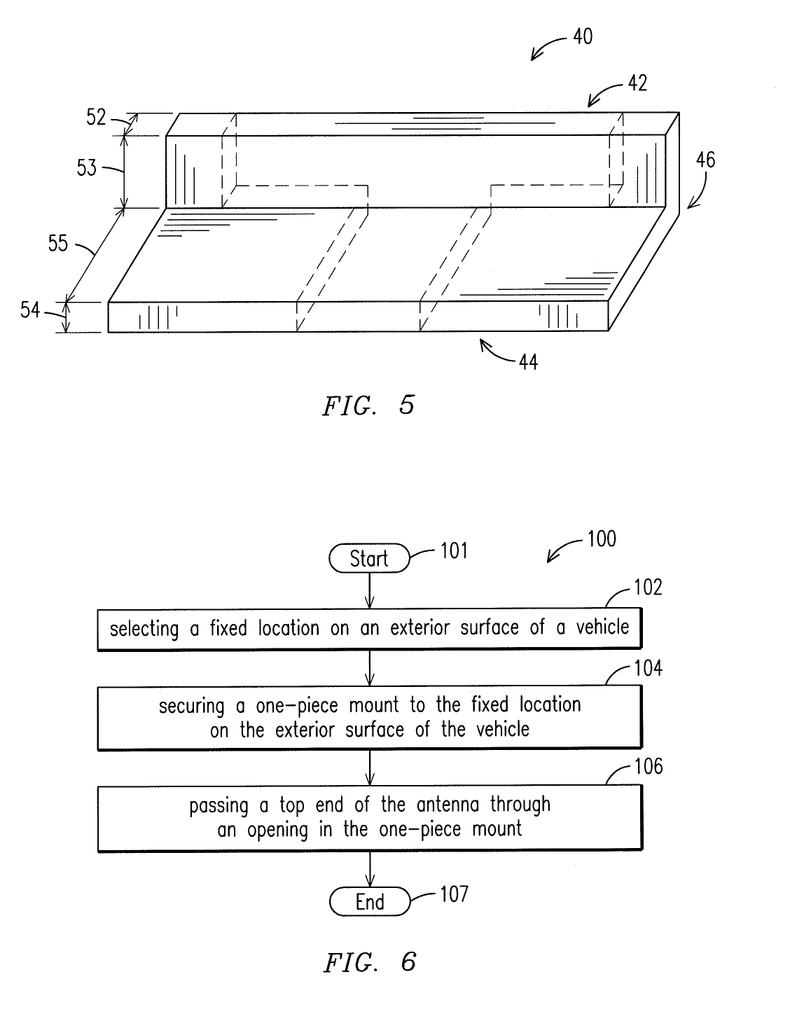

FIG. 6 illustrates a flowchart depicting an exemplary embodiment of a method 100 for reducing the sway of the antenna 12 of the vehicle 14. The method 100 begins at 101 by selecting 102 the fixed location 18 on the exterior surface, such as the side 26 of the vehicle 14. The method 100 further includes securing 104 the one-piece mount 16 to the fixed location 18 on the exterior surface of the vehicle 14. The method 100 further includes passing 106 the top end 22 of the antenna 12 through the opening 24 in the one-piece mount 16, before ending at 107.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for reducing the sway of a vertically-oriented antenna of a vehicle, comprising:
a one-piece mount secured to a fixed location on an exterior surface of the vehicle;
wherein said fixed location is selected such that upon said one-piece mount being secured to said fixed location, a top end of said vertically-oriented antenna is configured to pass through an opening in said one-piece mount, and said top end of said vertically-oriented antenna is positioned adjacent to said opening.

2. The system of claim 1, wherein said one-piece mount is secured to said fixed location on a side of the vehicle such that said opening is vertically oriented to receive said vertically-oriented antenna.

3. The system of claim 1, wherein said fixed location is selected such that upon securing said one-piece mount to said fixed location, said opening is positioned at a maximum threshold distance below said top end.

4. The system of claim 3, wherein said maximum threshold distance is based on a vertical height range over which said top end is configured to sway within said opening for a range of vehicle operating speed.

5. The system of claim 4, wherein said maximum threshold distance is greater than said vertical height range.

6. The system of claim 1, wherein a dimension of the one-piece mount is selectively determined, based on at least one of a dimension of the vertically-oriented antenna and a type of the vehicle.

7. The system of claim 1, wherein upon said one-piece mount being secured to said fixed location, a top portion of said vertically-oriented antenna, adjacent to said top end, is adjacent to said opening.

8. The system of claim 7, wherein said opening is configured to reduce a whipping sound produced by said top end and said top portion of said vertically-oriented antenna when said vehicle reaches a threshold speed.

9. The system of claim 1, wherein said one-piece mount is made from a material having a first member and a second member integrated over a substantial orthogonal joint.

10. The system of claim 9, wherein a first portion of said one-piece mount is secured to said fixed location, a second portion of said one-piece mount, integral with said first portion, is configured to include said opening and extend away from said fixed location, and wherein said first portion is cut out from said first member of said material and said second portion is cut out from said second member of said material.

11. The system of claim 10, wherein said material is a polyethylene angle stock.

12. The system of claim 10, wherein said material is selected such that a thickness of at least one of said first and second member is based on a respective dimension of said first and second portion.

13. The system of claim 1, wherein said one-piece mount is made from a non-conductive material.

14. The system of claim 1, wherein said one-piece mount includes a first portion secured to the fixed location along the exterior surface of the vehicle, and a second portion integral with the first portion, configured to include the opening and extend away from the fixed location; said first and second member are respectively aligned in a substantially orthogonal alignment.

15. A method for reducing the sway of a vertically-oriented antenna of a vehicle, comprising:
selecting a fixed location on an exterior surface of the vehicle;
securing a one-piece mount to the fixed location on the exterior surface of the vehicle; and
passing a top end of said vertically-oriented antenna through an opening in said one-piece mount, such that said top end of said vertically-oriented antenna is positioned adjacent to said opening.

16. The method of claim 15, wherein said selecting said fixed location includes:
determining that upon said securing the one-piece mount to the fixed location, said opening is to be positioned at a maximum threshold distance below said top end;
and wherein said method further includes calculating said maximum threshold distance based on a vertical height range of said top end as said vertically-oriented antenna sways within said opening for a range of vehicle operating speed.

17. The method of claim 15, further comprising selectively determining a dimension of the one-piece mount based on at least one of a dimension of the vertically-oriented antenna and a type of the vehicle.

18. The method of claim 15, further comprising forming said one-piece mount from a material having a first member and a second member integrated over a substantial orthogonal joint.

19. The method of claim 18, wherein said forming said one-piece mount from said material further includes:
cutting a first portion of said one-piece mount from said first member of the material;
cutting a second portion of said one-piece mount from said second member of the material;
wherein said first portion is secured to said fixed location, said second portion is integral with said first portion and is configured to include said opening and extend away from said fixed location.

20. A system for reducing the sway of a vertically-oriented antenna of a vehicle, comprising:
a mount secured to a fixed location on an exterior surface of the vehicle;
said fixed location being selectively determined such that upon a top end of said vertically-oriented antenna having passed through an opening in said mount, said top end is adjacent to said opening and a sway of said top end during an operation of the vehicle is reduced.
